(19) United States
(12) Patent Application Publication
(10) Pub. No.: US 2017/0151950 A1
(43) Pub. Date: Jun. 1, 2017

(54) DRIVING MODE SWITCHING SYSTEM AND METHOD FOR AUTOMOBILE

(71) Applicant: HON HAI PRECISION INDUSTRY CO., LTD., New Taipei (TW)

(72) Inventor: YU-TAN LIEN, New Taipei (TW)

(21) Appl. No.: 14/986,829

(22) Filed: Jan. 4, 2016

(30) Foreign Application Priority Data
Nov. 27, 2015 (TW) 104139644

(51) Int. Cl. B60W 30/182; B60W 10/04; B60W 10/20; G05D 1/02; B60Q 5/00

(52) U.S. Cl. CPC B60W 30/182; G05D 1/021; B60Q 5/005; B60W 10/20; B60W 10/04; B60Y 2300/182; B60W 2510/20; B60W 2540/10; B60W 2710/20; B60W 2710/00

(57) ABSTRACT

A driving mode switching system includes a driving mode detecting module, a steering wheel pressure sensor, an accelerator pedal pressure sensor, and a driving mode switching module. The driving mode detecting module can determine a driving mode of an automobile. The driving mode is one of a manual driving mode and an autonomous driving mode. In the manual driving mode, the automobile is controlled by a steering wheel and an accelerator pedal, and in the autonomous driving mode, the automobile is autonomously driven. The driving mode switching module is coupled to the driving mode detecting module and can switch the driving mode between the manual driving mode and the autonomous driving mode.

### FIELD

The subject matter herein generally relates to a driving mode switching system for automobiles and an automobile driving mode switching method for automobiles.

### BACKGROUND

Autonomous driving technology for automobile is a future trend about driving safety, time saving and convenience. An automobile can be driven in a manual driving mode or an autonomous driving mode.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an automobile driving mode switching system in one embodiment.

FIG. 2 is a table of toggle conditions for switching a driving mode of FIG. 1.

FIG. 3 is a diagrammatic view of an automobile with a driver in one embodiment.

FIG. 4 is similar to FIG. 3, but the driver's hand and foot are moved away from a steering wheel and an accelerate pedal.

FIG. 5 is a flowchart of an automobile driving mode switching method in one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the configurations described herein. However, it will be understood by those of ordinary skill in the art that the configurations described herein can be practiced without these specific details. In other instances, methods, procedures, and components have not been described in detail so as not to obscure the related relevant feature being described. Also, the description is not to be considered as limiting the scope of the configurations described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

An automobile driving mode switching system is described herein. A car is exampled in the following description, and other vehicle running in the road, such as truck or a bus can also be applied.

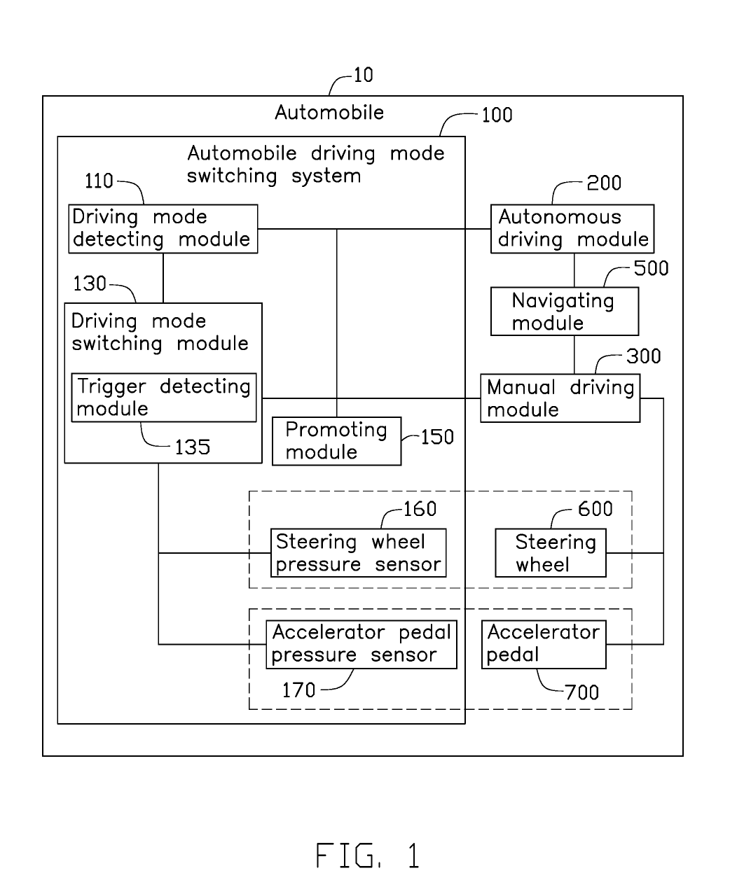

FIG. 1 illustrates a block view of an automobile driving mode switching system in one embodiment. An automobile 10 is equipped with an automobile driving mode switching system 100. The automobile driving mode switching system 100 can switch a driving mode of the automobile 10 between a manual driving mode and an autonomous driving mode. The automobile 10 further includes a navigating module 500, a steering wheel 600, and an accelerator pedal 700. The navigating module 500 can be a Global Positioning System (GPS) device to provide local position. An autonomous driving module 200 and a manual driving module 300 are coupled to the navigating module 500. The manual driving module 300 is coupled to the steering wheel 600 and the accelerator pedal 700.

When the manual driving module 300 works, the automobile 10 is driven in the manual driving mode, the automobile 10 can be driven by a driver with the steering wheel 600 and the accelerator pedal 700. In the manual driving mode, other operating components, such as a brake pedal, a shift of gear, a clutch pedal, and a horn can also be included.

When the autonomous driving module 200 works, the automobile 10 is driven in the automobile driving mode, the automobile 10 is under pilotless drive. In the automobile driving mode, the automobile 10 can employ the technology of sensor, Adaptive Cruise Control (ACC), Lane Keeping Aid (LKA), Electric Power Aided Steering (EPAS), active front wheel steering, active parking assist, Anti Lock Brake System (ABS), active traction control, Electronic Stability Control (ESC), blind area detect, communication between vehicles, and so on to realize semi-autonomous or autonomous driving.

The automobile driving mode switching system 100 includes a driving mode detecting module 110, a driving mode switching module 130, a promoting module 150, a steering wheel pressure sensor 160, and an accelerator pedal pressure sensor 170. The driving mode detecting module 110 is coupled to the autonomous driving module 200 and the manual driving module 300, and can be a hardware module, such as monitor to detect a present driving mode of the automobile. The driving mode switching module 130 is coupled to the driving mode detecting module 110, the autonomous driving module 200, and the manual driving module 300. The driving mode switching module 130 includes a trigger detecting module 135. The promoting module 150 is coupled to the driving mode switching module 130, the autonomous driving module 200, and the manual driving module 300. The steering wheel pressure sensor 160 is disposed on the steering wheel 600. The accelerator pedal pressure sensor 170 is disposed on the accelerator pedal 700.

The driving mode switching module 130 can detect a pressure signal from the steering wheel pressure sensor 160 or the accelerator pedal pressure sensor 170 to determine if the steering wheel 600 and the accelerator pedal 700 are contacted by the driver, for example, the steering wheel 600 is held by the driver and the accelerator pedal 700 is contacted by the driver's foot. Specifically, when the steering wheel 600 is held by a driver's hand, the driving mode switching module 130 can detect a steering wheel pressure signal via the steering wheel pressure sensor 160, and when the accelerator pedal 700 is stepped on by a driver's foot, the driving mode switching module 130 can detect an accelerator penal pressure signal via the accelerator pedal pressure sensor 170. When the hand is moved away from the steering wheel 600, the driving mode switching module 130 can detect a steering wheel non-pressure signal from the steering wheel pressure sensor 160, and when the foot is moved away from the accelerator pedal 700, the driving mode switching module 130 can detect an accelerator penal non-pressure signal from the accelerator pedal pressure sensor 170. The trigger detecting module 135 can further recognize the steering wheel pressure signal, the steering wheel non-pressure signal, the accelerator penal pressure signal, and the accelerator penal non-pressure signal through duration.

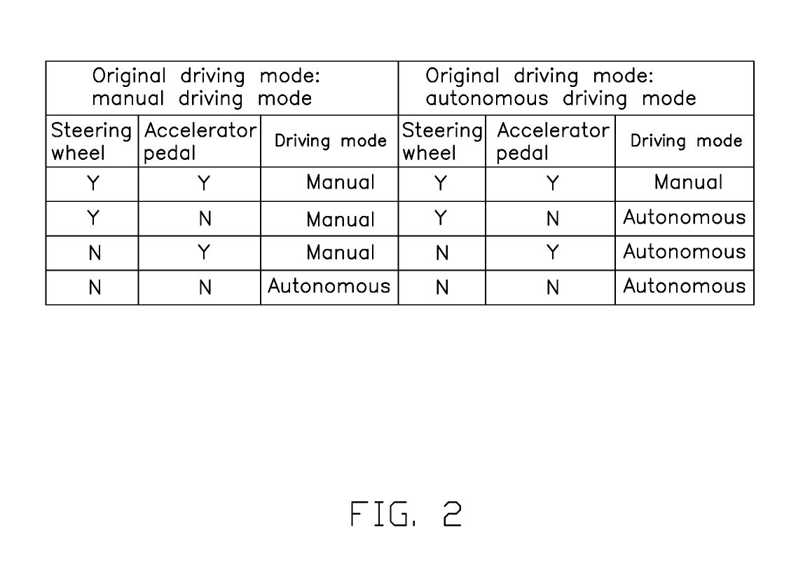

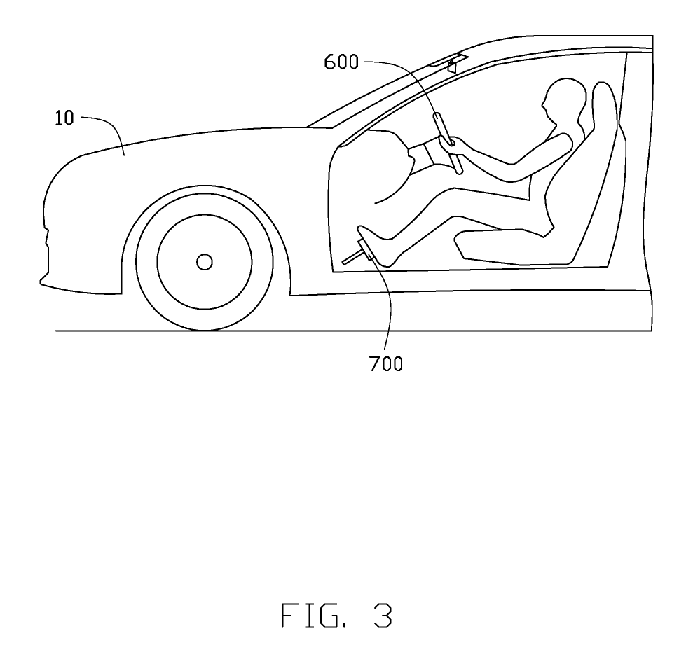

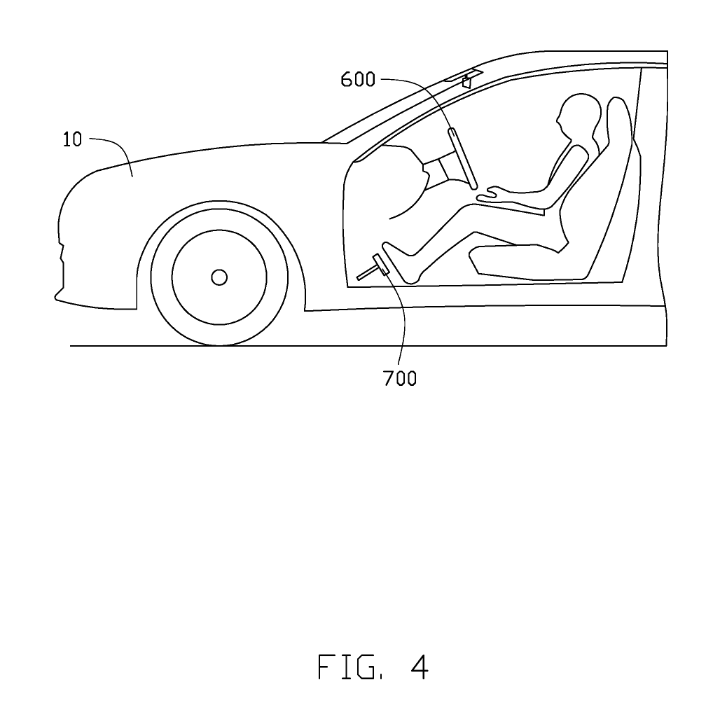

FIG. 2 illustrates a table showing toggle conditions for switching driving modes between the automatic driving mode and the manual driving mode. FIG. 3 and FIG. 4 illustrate two schematic views of the automobile 10 each with a driver. The automobile 10 can be driven in the manual mode at the start. The automobile driving mode switching system 100 can switch the manual mode to the autonomous driving mode, when the automobile driving mode switching system 100 detects that the hand and the foot are both removed away from the steering wheel pressure sensor 160 and the accelerator pedal pressure sensor 170. If only the hand leaves the steering wheel pressure sensor 160 or only the foot leaves the accelerator pedal pressure sensor 170, the automobile 10 remains in the manual driving mode. The automobile 10 can be driven in the autonomous driving mode. The automobile driving mode switching system 100 can switch the autonomous driving mode to the manual driving mode when the automobile driving mode switching system 100 detects that the hand presses the steering wheel pressure sensor 160 and the foot presses the accelerator pedal pressure sensor 170. If only the hand presses the steering wheel pressure sensor 160 or only the foot presses the accelerator pedal pressure sensor 170, the automobile 10 remains the autonomous driving mode.

To be specific, the automobile 10 is driven in the manual driving mode, while the hand is holding the steering wheel 600 and the foot is stepping on the accelerator pedal 700 simultaneously, the automobile driving mode switching system 100 maintains the automobile 10 in the manual driving mode. When the hand is removed from the steering wheel 600 and the foot remains stepping on the accelerator pedal 700, the automobile driving mode switching system 100 keeps the automobile 10 running in the manual driving mode. When the foot is removed from the accelerator pedal 700 and the hand remains holding the steering wheel 600, the automobile driving mode switching system 100 keeps the automobile 10 running in the manual driving mode. When the hand is removed from the steering wheel 600 and the foot is simultaneously not engaged with the accelerator pedal 700, the manual driving mode is switched to the automatic driving mode.

When the hand and foot are not holding the steering wheel 600 and stepping on the accelerator pedal 700 simultaneously, the automobile driving mode switching system 100 keeps the automobile 10 running in the autonomous driving mode. While the hand is removed from the steering wheel 600 and the foot remains stepping on the accelerator pedal 700, the automobile driving mode switching system 100 maintains the automobile 10 in the autonomous driving mode. When the foot is removed from the accelerator pedal 700 and the hand remains holding the steering wheel 600, the automobile driving mode switching system 100 keeps the automobile 10 running in the autonomous driving mode. When the hand is holding the steering wheel 600 and the foot is stepping on the accelerator pedal 700 simultaneously, the automobile driving mode switching system 100 detects and switches the autonomous driving mode to the manual driving mode.

When the automobile driving mode switching system 100 is switched to the autonomous driving mode from the manual driving mode, the promoting module 150 can prompt a mode switching reminder to the driver. The reminder can be one of user interface, sound, and shock of seat. When the automobile driving mode switching system 100 is switched to the manual driving mode from the autonomous driving mode, the reminder can also be prompted. After the automobile driving mode switching system 100 is switched to the autonomous driving mode from the manual driving mode, the promoting module 150 can prompt a navigation setting reminder to the driver, when the automobile driving mode switching system 100 detects the navigating module 500 is not running.

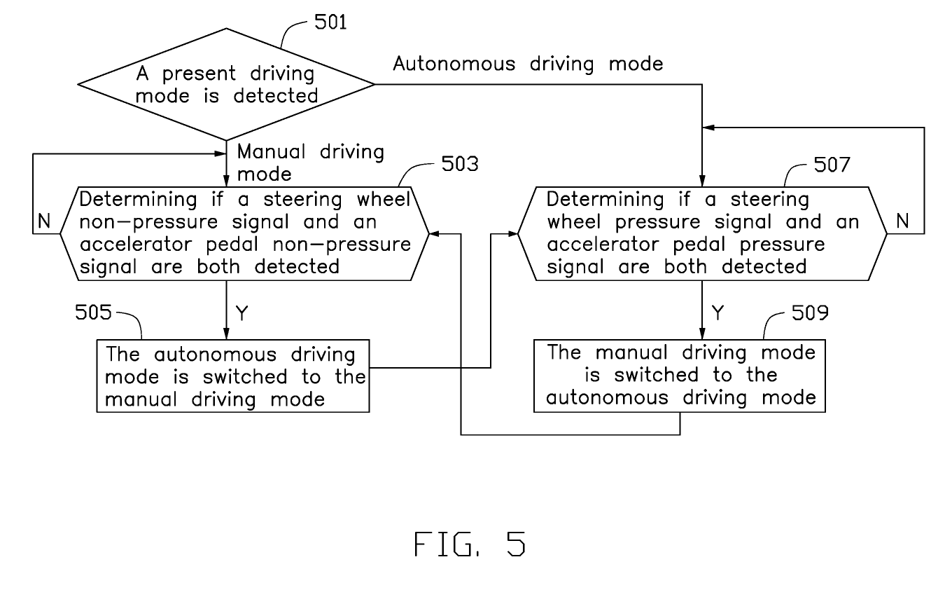

FIG. 5 illustrates a driving mode switching method in one embodiment. The example method is provided by way of example, as there are a variety of ways to carry out the method. The driving mode switching method described below can be carried out using the configurations illustrated in FIG. 1, for example, and various elements of these figures are referenced in explaining the example method. Each block shown in FIG. 5 represents one or more processes, methods or subroutines, carried out in the example method. Furthermore, the illustrated order of blocks is illustrative only and the order of the blocks can change according to the present disclosure. Additional blocks can be added or fewer blocks can be utilized, without departing from this disclosure. The example method can begin at block 501. The driving mode switching includes the following blocks.

Block 501, a driving mode detecting module detects a present driving mode, a driving mode is one of a manual driving mode and an autonomous driving mode. In the manual driving mode, an automobile can be controlled by at least a steering wheel and an accelerator pedal. In the autonomous driving mode, the automobile can be pointlessly driven. If the manual driving mode is detected, the process transitions to block 503, and if the autonomous driving mode is detected, the process transitions to block 507.

Block 503, a driving mode switching module determines if a steering wheel non-pressure signal and an accelerator pedal non-pressure signal are both detected. When the steering wheel non-pressure signal and the accelerator pedal non-pressure signal are both detected, the process transitions to block 505. When the steering wheel non-pressure signal and the accelerator pedal non-pressure signal are not detected, the block 503 is re-executed.

Block 505, the driving mode switching module switches the present driving mode from the autonomous driving mode to the manual driving mode.

Block 507, the driving mode switching module determines if a steering wheel pressure signal and an accelerator pedal pressure signal are both detected, if the steering wheel pressure signal and the accelerator pedal pressure signal are both detected, the process transitions to block 509, if the steering wheel pressure signal and the accelerator pedal pressure signal are not detected, the block 507 is re-executed.

Block 509, the driving mode switching module switches the present driving mode from the manual driving mode to the autonomous driving mode.

The driving mode switching method can further include the follow blocks. When the automobile driving mode switching system 100 is switched to the autonomous driving mode from the manual driving mode, the promoting module 150 prompts a mode switching reminder to the driver. The reminder can be one of user interface, sound, and shock of seat. When the automobile driving mode switching system 100 is switched to the manual driving mode from the autonomous driving mode, the reminder can also be prompted. After the automobile driving mode switching system 100 is switched to the autonomous driving mode from the manual driving mode, the promoting module 150 prompts a navigation setting reminder to the driver, when the automobile driving mode switching system 100 detects the navigating module 500 is not running.

Autonomous driving switching system and method can detect the driver's behavior to reduce human errors. When the driver encounters an emergency situation and cause his hands and feet left the driving position while driving, the automobile can be switched to the automatic driving mode, and the risk of accident can be reduced.

The configurations shown and described above are only examples. Many details are often found in the art such as the other features of a tread depth measuring system. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the configurations described above may be modified within the scope of the claims.

What is claimed is:

1. A driving mode switching system for switching a present driving mode of an automobile between a manual driving mode and an autonomous driving mode, the system comprising:
a driving mode detecting module configured to determine the present driving mode of the automobile, the present driving mode being one of the manual driving mode and the autonomous driving mode, in the manual driving mode, the automobile being controlled by a steering wheel and an accelerator pedal, and in the autonomous driving mode, the automobile being autonomously driven;
a steering wheel pressure sensor, configured for detecting a steering wheel pressure signal when the steering wheel is contact, and a steering wheel non-pressure signal when the steering wheel is not contact;
an accelerator pedal pressure sensor, configured for detecting an accelerator pedal non-pressure signal when the accelerator pedal is contact, and a accelerator pedal non-pressure signal when the accelerator pedal is not contact; and
a driving mode switching module, coupled to the driving mode detecting module and configured to switch the driving mode between the manual driving mode and the autonomous driving mode,
wherein when in the manual driving mode, and the steering wheel non-pressure signal and the accelerator pedal non-pressure signal are both detected, the driving mode switching module is configured to switch the manual driving mode to the autonomous driving mode, and when in the autonomous driving mode, the steering wheel pressure signal and the accelerator pedal pressure signal are both detected, the driving mode switching module is configured to switch the autonomous driving mode to the manual driving mode.

2. The driving mode switching system of claim 1, further comprising a promoting module, wherein the promoting module is coupled to the driving mode switching module, and the promoting module is configured to prompt a navigation setting reminder, when the manual driving mode is switched to the autonomous driving mode.

3. The driving mode switching system of claim 1, further comprising a promoting module, wherein the promoting module is coupled to the driving mode switching module, when the autonomous driving mode is switched to the manual driving mode, the promoting module is configured to prompt a mode switching reminder.

4. The driving mode switching system of claim 3, wherein the reminder is one of user interface, sound, and shock of seat.

5. The driving mode switching system of claim 1, further comprising a promoting module, wherein the promoting module is coupled to the driving mode switching module, when the manual driving mode is switched to the autonomous driving mode, the promoting module is configured to prompt a mode switching reminder.

6. The driving mode switching system of claim 5, wherein the reminder is one of user interface, sound, and shock of seat.

7. The driving mode switching system of claim 1, wherein the steering wheel pressure sensor is disposed on the steering wheel, the accelerator pedal pressure sensor is disposed on the accelerator pedal.

8. The driving mode switching system of claim 7, wherein the driving mode switching module further comprises a trigger detecting module, the trigger detecting module is configured to recognize the steering wheel pressure signal, the steering wheel non-pressure signal, the accelerator penal pressure signal, and the accelerator penal non-pressure signal through duration.

9. An driving mode switching method for switching a present driving mode of an automobile between a manual driving mode and an autonomous driving mode, the method comprising:
a driving mode detecting module determining the present driving mode of the automobile, the driving mode being one of the manual driving mode and the autonomous driving mode, in the manual driving mode, the automobile being controlled by a steering wheel and an accelerator pedal, and in the autonomous driving mode, the automobile being autonomously driven;
detecting if the steering wheel is contact via a steering wheel pressures sensor; and
detecting if the accelerator pedal is contact via an accelerator pedal sensor;
when in the manual driving mode, a steering wheel non-pressure signal from the steering wheel pressures sensor and an accelerator pedal non-pressure signal from the accelerator pedal sensor are both detected, the driving mode switching module switching the manual driving mode to the autonomous driving mode; and
when in the autonomous driving mode, and a steering wheel pressure signal from the steering wheel pressures sensor and an accelerator pedal pressure signal from the accelerator pedal sensor are both detected, the driving mode switching module switching the autonomous driving mode to the manual driving mode.

10. The driving mode switching method of claim 9, further comprising prompting a navigation setting reminder when the manual driving mode is switched to the autonomous driving mode.

11. The driving mode switching method of claim 9, further comprising prompting a mode switching reminder when the autonomous driving mode is switched to the manual driving mode.

12. The driving mode switching method of claim 11, wherein the reminder is one of user interface, sound, and shock of seat.

13. The driving mode switching method of claim 9, further comprising prompting a mode switching reminder when the autonomous driving mode is switched to the autonomous driving mode.

14. The driving mode switching method of claim 13, wherein the reminder is one of user interface, sound, and shock of seat.

15. The driving mode switching method of claim 9, further comprising recognizing the steering wheel pressure signal, the steering wheel non-pressure signal, the accelerator penal pressure signal, and the accelerator penal non-pressure signal through duration.
